(19) United States
(12) Patent Application Publication
(10) Pub. No.: US 2009/0075768 A1
(43) Pub. Date: Mar. 19, 2009

(54) Tensioner

(76) Inventors: Alben D'Silva, Windsor (CA); John Harvey, Novi, MI (US); Oliver Stegelmann, Strathroy (CA)

Correspondence Address: Jeffrey Thurnau;The Gates Corporation, MS: IP Law Dept. 10-A3, 1551 Wewatta Street, Denver, CO, 80202, US

(21) Appl. No.: 11/900,716

(22) Filed: Sep. 13, 2007

(51) Int. Cl. F16H 7/08

(52) U.S. Cl. 474/135

(57) ABSTRACT

A tensioner comprising a base, a pivot arm rotationally connected to the base, a pulley journalled to the pivot arm, a torsion spring engaged between the base and the pivot arm for biasing the pivot arm, a first damping member and a second damping member, each engaged with the base such that each cannot rotate with respect to the base but can move axially, a friction member connected to and rotationally moveable with the pivot arm, the friction member disposed between the first damping member and the second damping member, and the torsion spring exerting a normal force directly upon the first damping member, thereby pressing the first damping member and the second damping member into frictional engagement with the friction plate.

### FIELD OF THE INVENTION

The invention relates to a tensioner, and more particularly, to a tensioner having a friction member disposed for rotation between a first damping member and a second damping member and having a normal force applied by a torsional spring.

### BACKGROUND OF THE INVENTION

The present invention is directed to a belt tensioner for a transmission belt system, and more specifically, to an improved damper assembly for the belt tensioner and a method for constructing the belt tensioner incorporating the improved damper assembly.

The main purpose of an automatic belt tensioner is to prolong the life of an engine or accessory drive belt. The most typical use for such automatic belt tensioners is on front-end accessory drives in an automobile engine. This drive includes pulley sheaves for each accessory the belt is required to power, such as the air conditioner, water pump, fan and alternator. Each of these accessories requires varying amounts of power at various times during operation. These power variations, or torsionals, create a slackening and tightening situation of each span of the belt. The belt tensioner is utilized to absorb these torsionals through use of an internally mounted torsion spring.

Representative of the art is U.S. Pat. No. 6,575,860 which discloses a belt tensioner for a power transmission belt system includes: (a) a base housing having a pivot shaft extending therefrom; (b) a tension arm pivotally mounted on the pivot shaft at a proximal end thereof, the proximal end of the tension arm including a rub surface and the distal end of the tension arm adapted to contact a power transmission belt; (c) a torsion spring operatively coupled between the base housing and the tension arm and adapted to bias the distal end of the tension arm against the power transmission belt; and (d) a damper assembly coupled to the housing, the damper assembly including: (1) a body of friction material that includes a friction surface adjacent to and facing the rub surface of the tension arm and (2) a damper spring integral with the body of friction material and biasing the body of friction material and associated friction surface against the rub surface of the tension arm.

What is needed is a tensioner having a friction member disposed for rotation between a first damping member and a second damping member and having a normal force applied by a torsional spring. The present invention meets this need.

### SUMMARY OF THE INVENTION

The primary aspect of the invention is to provide a tensioner having a friction member disposed for rotation between a first damping member and a second damping member and having a normal force applied by a torsional spring.

Other aspects of the invention will be pointed out or made obvious by the following description of the invention and the accompanying drawings.

The invention comprises a tensioner comprising a base, a pivot arm rotationally connected to the base, a pulley journalled to the pivot arm, a torsion spring engaged between the base and the pivot arm for biasing the pivot arm, a first damping member and a second damping member, each engaged with the base such that each cannot rotate with respect to the base but can move axially, a friction member connected to and rotationally moveable with the pivot arm, the friction member disposed between the first damping member and the second damping member, and the torsion spring exerting a normal force directly upon the first damping member, thereby pressing the first damping member and the second damping member into frictional engagement with the friction plate.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the tensioner.

FIG. 2 is a side view of the tensioner.

FIG. 3 is an exploded view of the tensioner.

### DETAILED DESCRIPTION OF THE PREFERRED EMBODIMENT

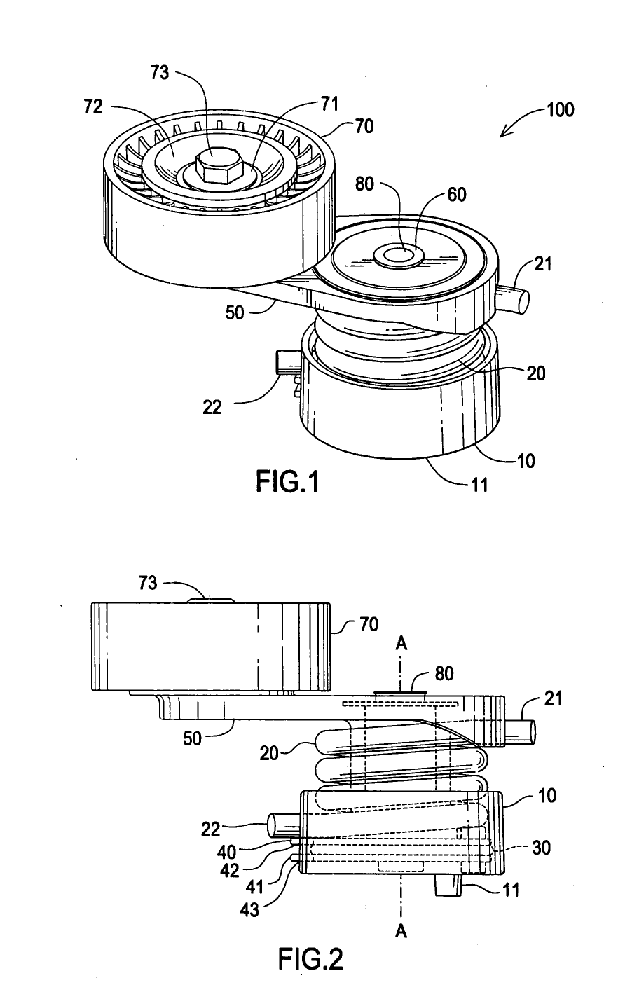

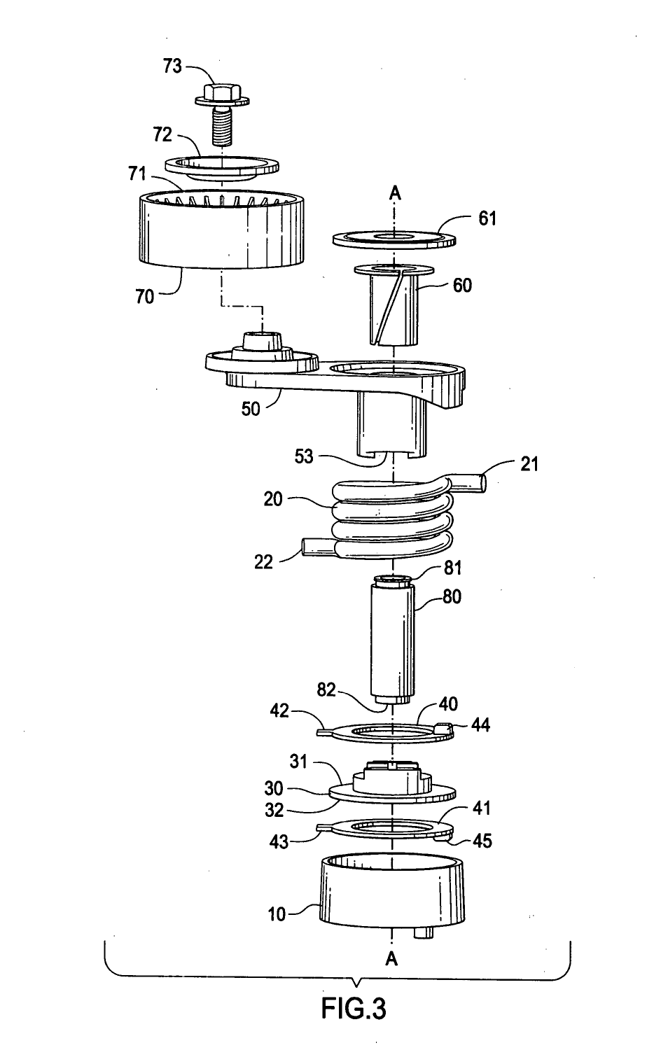

FIG. 1 is a perspective view of the tensioner. Tensioner 100 comprises a base 10 which can be fastened to a mounting surface such as an engine block (not shown). Tab 11 prevents base 10 from rotating as well as orients the tensioner with respect to a belt drive system (not shown). Pivot arm 50 is pivotally connected to base 10 by shaft 80, see FIG. 3. Low-friction bush 60 is disposed between shaft 80 and pivot arm 50. Bush 60 facilitates rotational movement of pivot arm 50 about shaft 80. Bush 60 comprises any suitable low friction material known in the art.

Torsion spring 20 is engaged between base 10 and pivot arm 50. End 22 engages base 10 and end 21 engages pivot arm 50. Torsion spring 20 exerts a spring force to bias pivot arm 50 and thereby apply a force to a belt (not shown) through pulley 70.

Pulley 70 is journalled to pivot arm 50 through bearing 71. Dust cover 72 keeps debris from entering bearing 71. Fastener 73 retains bearing 71 on pivot arm 50.

The damping mechanism comprising the damping member 40, damping member 41 and friction plate 30 is contained within the base 10.

FIG. 2 is a side view of the tensioner. Damping member 40 is engaged with base 10 by tab 42. Damping member 41 is engaged with base 10 by tab 43. Each tab 42, 43 prevents damping member 40 and damping member 41 respectively, from rotating with respect to base 10. Damping member 40 and damping member 41 are each moveable in an axial direction with respect to shaft 80. The axial direction is shown in FIG. 3 along axis A-A.

Friction plate 30 is disposed between damping member 40 and damping member 41.

When the tensioner is assembled, torsion spring 20 is subjected to some compression. Compressing torsion spring 20 presses damping member 40, damping member 41 and friction plate 30 together against base 10 by the normally applied torsion spring force. A frictional force is the product of a normal force and the coefficient of friction of the surfaces that are in contact. Torsion spring 20 provides the necessary normal force. The normal force can be adjusted by increasing or decreasing the amount of compression of torsion spring 20. Adjusting the normal force has the effect of adjusting the frictional force, which in turn adjusts the amount of damping applied to the pivot arm by the damping members.

The stacked arrangement of the damping members with the friction plate 30 can be adjusted to accommodate a plurality of damping members and friction plates. The number of each is determined by the desired damping coefficient.

FIG. 3 is an exploded view of the tensioner.

Damping member 40 is contained between torsion spring 20 and friction plate 30. Damping member 41 is contained between friction plate 30 and base 10. Damping member 40 engages friction plate surface 31. Damping member 41 engages friction plate surface 32 and base 10.

Each damping member 40 and 41 comprises surfaces having a predetermined coefficient of friction (μ). Each damping member 40, 41 and friction plate 30 may comprise either a non-metallic or metallic material known in the tensioner damping arts and selected based upon factors such as coefficient of friction, wear resistance, operating temperature and so on. Damping members 40 and 41 damp angular oscillations of pivot arm 50 during operation of the tensioner.

Friction plate 30 is connected to shaft 80 such that friction plate 30 rotates with shaft 80. Damping plate 40 and damping plate 41 are each engaged with base 10 such that neither rotates within base 10. However, damping plate 40 may move axially along the axis A-A within base 10 as the friction plate 30 wears through use. The intended wear component is the friction plate 30. Friction plate 30 is fixed rotationally to the shaft 80, but it is allowed to move axially along shaft 80 as the friction plate wears through use.

Each damping member 40, 41 comprises tabs 42, 43. Each tab 42, 43 may extend in any direction from damping member 40 and damping member 41. Tabs 42, 43 allow each damping member 40, 41 to move along axis A-A, but not to rotate.

Tab 44 projects from damping member 40. A volute of spring 20 engages tab. 44 in order to apply a spring load to the damping member 40. Tab 45 projects from damping member 41. Tab 45 is cooperatively disposed opposite tab 44 so as to provide a reaction point for the spring load applied to tab 44. Tab 45 bears upon base 10.

Bush 60 is pressed into the pivot are 50 and is slidingly engaged about the outer perimeter of shaft 80. In an alternate embodiment the outer portion of bush 60 may slidingly engage the inner surface 53 of pivot arm 50 and have a press fit on the OD of shaft 80. Press fit washer 61 engages an end 81 of shaft 80 to hold the tensioner together. Washer 61 may also comprise a snap ring. A fastener such as a bolt (not shown) is inserted into bore 82 for fastening the tensioner to a mounting surface, such as a vehicle engine (not shown).

Although forms of the invention have been described herein, it will be obvious to those skilled in the art that variations may be made in the construction and relation of parts and method without departing from the spirit and scope of the invention described herein.

We claim:

1. A tensioner comprising:
a base;
a pivot arm rotationally connected to the base;
a pulley journalled to the pivot arm;
a torsion spring engaged between the base and the pivot arm for biasing the pivot arm;
a first damping member and a second damping member, each engaged with the base such that each cannot rotate with respect to the base but can move axially;
a friction member connected to and rotationally moveable with the pivot arm, the friction member disposed between the first damping member and the second damping member; and
the torsion spring exerting a normal force directly upon the first damping member, thereby pressing the first damping member and the second damping member into frictional engagement with the friction plate.

2. The tensioner as in claim 1, wherein the friction member is axially moveable along an axis A-A.

3. The tensioner as in claim 1, wherein the first damping member and the second damping member are axially moveable along an axis A-A.

4. The tensioner as in claim 1 further comprising two or more friction plates.
